(19) United States
(12) Patent Application Publication
(10) Pub. No.: US 2011/0253709 A1
(43) Pub. Date: Oct. 20, 2011

(54) Flat Panel Display Device

(75) Inventors: Tae-Wook Kang, Yongin-City (KR); Hun Kim, Yongin-City (KR); Jang-Hwan Shin, Yongin-City (KR)

(73) Assignee: SAMSUNG MOBILE DISPLAY CO., LTD., Yongin-City (KR)

(21) Appl. No.: 13/081,327

(22) Filed: Apr. 6, 2011

(30) Foreign Application Priority Data
Apr. 15, 2010 (KR) 10-2010-0034953

(51) Int. Cl. H01K 1/28

(52) U.S. Cl. 220/2.1 R

(57) ABSTRACT

In a flat panel display device, a crack or burr is prevented from occurring by disposing a plurality of supports between adjacent connection members, and the supports are separated from the connection members by a predetermined distance. The flat panel display device comprises: a first substrate, including a plurality of active areas and a plurality of non-active areas; an emission unit disposed in the plurality of active areas; a second substrate connected to the first substrate; a plurality of connection members respectively disposed in the plurality of non-active areas and combining the first substrate and the second substrate with each other; and a plurality of supports disposed between the adjacent connection members so as to be respectively separated from the connection members, and supporting the first and second substrates, wherein the plurality of supports are separated from one another.

### CLAIM OF PRIORITY

This application makes reference to, incorporates the same herein, and claims all benefits accruing under 35 U.S.C. §119 from an application earlier filed in the Korean Intellectual Property Office on the 15 Apr. 2010 and there duly assigned Serial No. 10-2010-0034953.

### BACKGROUND OF THE INVENTION

1. Field of the Invention

The present invention relates to a flat panel display device, in which a crack or burr is prevented during the fabrication process.

2. Description of the Related Art

When manufacturing flat panel display devices, sealing is generally performed so as to guarantee that the flat panel display devices are air tight. A sealing method, in which connection members are applied between a lower substrate and an upper substrate and the connection members are melted by using a laser, is usually used.

Generally, a plurality of flat panel display devices are manufactured on large-sized first and second substrates, and are then cut. However, a stress difference occurs between adjacent connection members during the cutting process, and thus a crack or burr may occur around a cutting line.

### SUMMARY OF THE INVENTION

The present invention comprises a flat panel display device in which a crack or burr is prevented from occurring by disposing a plurality of supports between adjacent connection members so as to be separated from the connection members.

According to an aspect of the present invention, a flat panel display device includes: a first substrate, including a plurality of active areas and a plurality of non-active areas; an emission unit disposed in the plurality of active areas; a second substrate connected to the first substrate; a plurality of connection members respectively disposed in the plurality of non-active areas and combining the first substrate and the second substrate with each other; and a plurality of supports disposed between the adjacent connection members so as to be respectively separated from the connection members, and supporting the first and second substrates, wherein the plurality of supports are separated from one another.

The supports may include the same material as the material used to form the connection members.

The supports may include an organic material, an inorganic material or an organic/inorganic composite material for forming the emission unit.

The supports may include the same one or a plurality of materials selected from the group consisting of materials used to form an interlayer insulating layer, a metal layer, a planarization layer, and a pixel defining layer.

The height of the supports may be greater than or equal to the height of the connection members.

The height of the supports may be greater than the height of the connection members by 3 μm or less.

The height of the supports may be smaller than or equal to the height of the connection members.

The height of the supports may be smaller than the height of the connection members by 0.4 μm or less.

The width of the supports may be 200 to 400 μm.

When the plurality of supports are separated from one another, the distance between the supports may be greater than or equal to the width of the supports.

Cross-sections of the supports may be polygonal or circular.

The flat panel display device may further include a reinforcement material filled around the supports, around outer portions of the connection members, and in a space formed between the first and second substrate, wherein the supports have such a shape as to form a space in which the reinforcement material is filled.

Cross-sections of the supports may be H-shaped or bar-shaped.

The active areas may be formed in portions of the first substrate, and the non-active areas may be formed so as to surround the active areas.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a flat panel display device according to an embodiment of the present invention;

FIG. 2 is an enlarged perspective view showing portions of the flat panel display device illustrated in FIG. 1;

FIG. 3 is a cross-sectional view of an emission unit of FIG. 2;

FIG. 4A is a cross-sectional view taken along a line II-II of FIG. 2;

FIG. 4B illustrates a reinforcement material filled in a portion of FIG. 4A;

FIG. 5 is a schematic plan view of the flat panel display device of FIG. 2; and

FIGS. 6 thru 8 are schematic plan views of a flat panel display device according to another embodiment of the present invention.

### DETAILED DESCRIPTION OF THE INVENTION

Reference will now be made in detail to exemplary embodiments, examples of which are illustrated in the accompanying drawings. However, the exemplary embodiments are not limited to the embodiments illustrated hereinafter, and the embodiments herein are rather introduced to provide easy and complete understanding of the scope and spirit of exemplary embodiments. In the drawings, the thicknesses of layers and regions are exaggerated for clarity.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

The terminology used herein is for the purpose of describing particular embodiments only and is not intended to limit the invention to such exemplary embodiments. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The present invention will now be described more fully with reference to the accompanying drawings in which exemplary embodiments of the invention are shown.

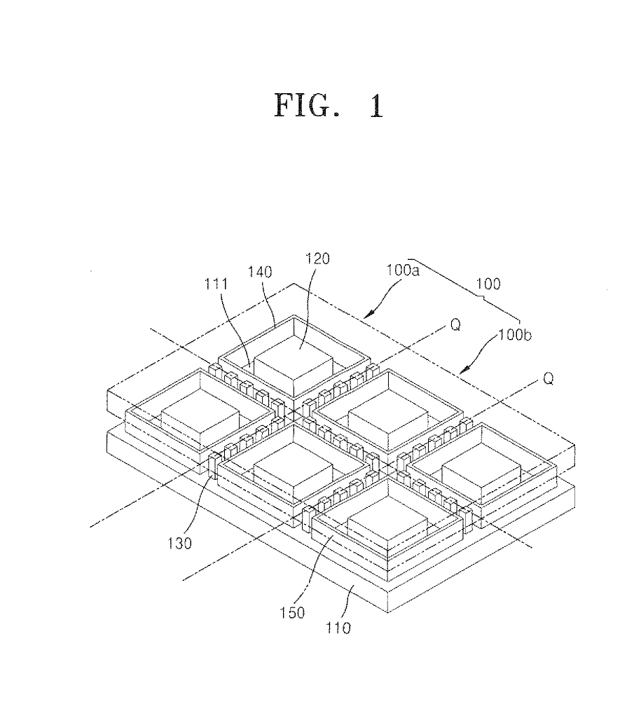

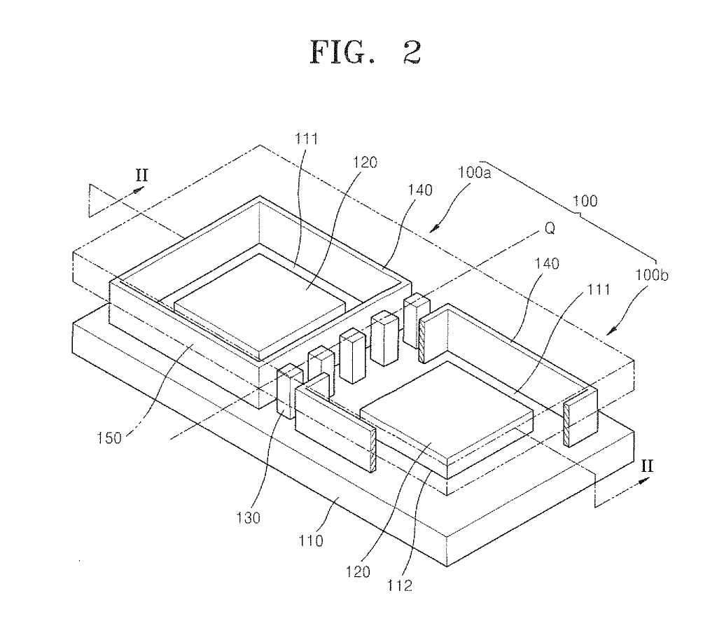

FIG. 1 is a perspective view of a flat panel display device according to an embodiment of the present invention, and FIG. 2 is an enlarged perspective view showing portions of the flat panel display device illustrated in FIG. 1.

Referring to FIG. 1, at least one or more flat panel display devices 100, including a plurality of active areas 112 shown in FIG. 2 and a plurality of non-active areas 111, are formed on a first substrate 110. A second substrate 150 is disposed on the first substrate 110 so as to seal the active areas 112. A cutting line Q for separating the flat panel display devices 100 from one another is formed in the first and second substrates 110 and 150, respectively. Hereinafter, for convenience of explanation, two flat panel display devices continuously arranged, from among a plurality of flat panel display devices 100, are referred to as a first flat panel display device 100a and a second flat panel display device 100b. For example, the cutting line Q is formed at an interface between non-active areas 111 of the first flat panel display device 100a and non-active areas 111 of the second flat panel display device 100b. In an embodiment of the present invention, one or more supports 130 are disposed on the cutting line Q between the first substrate 110 and the second substrate 150.

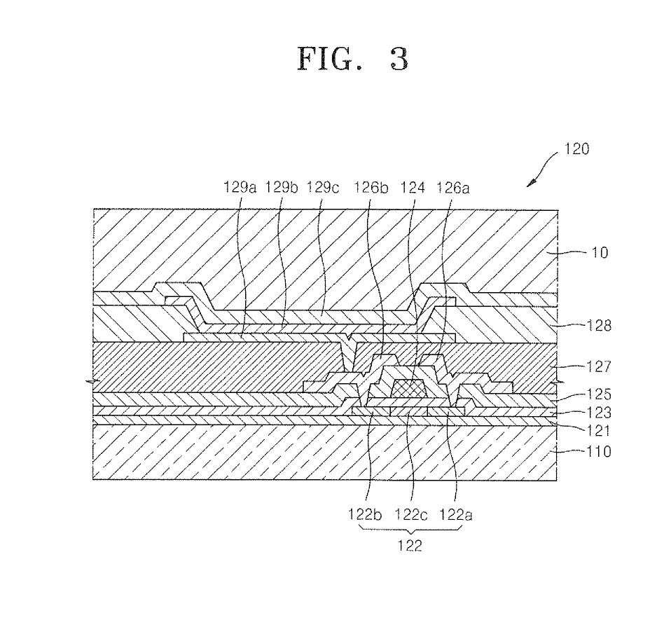

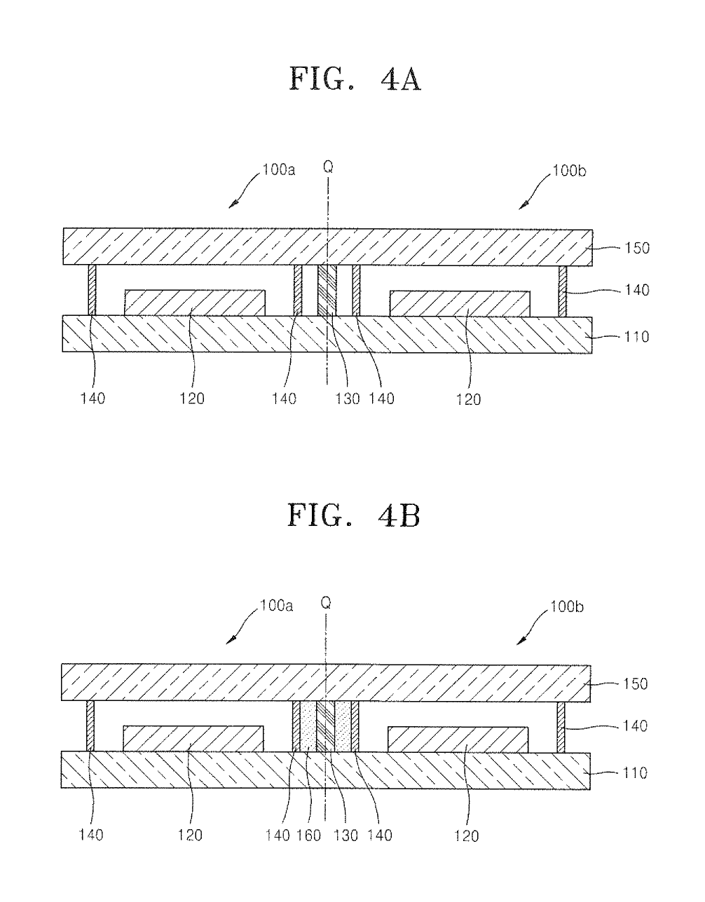

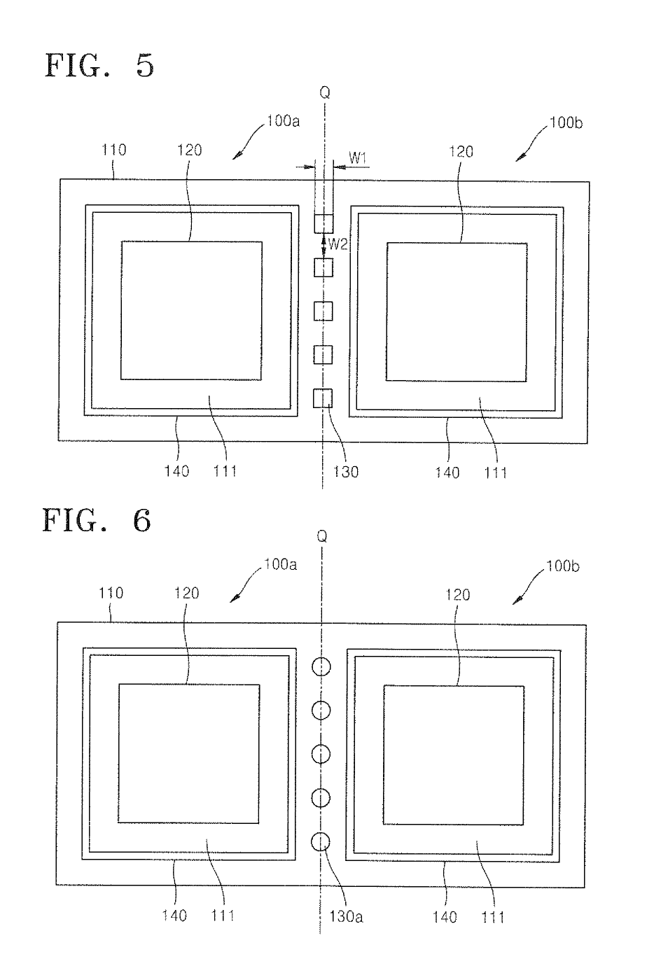

FIG. 3 is a cross-sectional view of an emission unit of FIG. 2, FIG. 4A is a cross-sectional view taken along a line II-II of FIG. 2, FIG. 4B illustrates a reinforcement material filled in a portion of FIG. 4A, and FIG. 5 is a schematic plan view of the flat panel display device of FIG. 2.

Referring to FIGS. 2 thru 5, the flat panel display device 100 of FIG. 1 may include the first substrate 110, the emission unit 120, the supports 130, connection members 140, and the second substrate 150.

The flat panel display device 100 of FIG. 1 may be an organic light-emitting display device, a liquid crystal display (LCD) device, a plasma display device (PDP), or the like. Hereinafter, the case where the flat panel display device 100 is an organic light-emitting display device will be described.

The flat panel display device 100, which is an organic light-emitting display device, includes a first substrate 110 and a second substrate 150 which face each other, and the first substrate 110 and the second substrate 150 are sealed by the connection members 140.

The first substrate 110 includes a plurality of non-active areas 111 and a plurality of active areas 112, and the emission unit 120 may be disposed in the active areas 112. The active areas 112 may be formed in portions of the first substrate 110, and the non-active areas 111 may be formed so as to surround the active areas 112. The connection members 140 may be disposed in the non-active areas 111 of the first substrate 110, may be separated from the active areas 112 by a predetermined distance, and may surround the active areas 112. In an embodiment of the present invention, the flat panel display device 100 may further include the supports 130. The supports 130 will be described later.

FIG. 3 is a cross-sectional view of an example of one pixel of the emission unit 120.

As illustrated in FIG. 3, an insulating layer 121, such as a barrier layer and/or a buffer layer, for preventing impurity ions from being dispersed into the first substrate 110, for preventing moisture or external air from permeating the first substrate 110, and for planarizing the surface of the first substrate 110, may be formed on a top surface of the first substrate 110.

An active layer 122, which is in the form of a thin film transistor (TFT), is formed of a semiconductor material on the insulating layer 121, and a gate insulating layer 123 is formed so as to cover the active layer 122. The active layer 122 may be formed of an inorganic semiconductor, such as amorphous silicon or polysilicon, or an organic semiconductor. The active region 122 includes a source region 122a, a drain region 122b, and a channel region 122c interposed therebetween.

A gate electrode 124 is disposed on the gate insulating layer 123, and an interlayer insulating layer 125 is formed so as to cover the gate electrode 124. A source electrode 126a and a drain electrode 126b are disposed on the interlayer insulating layer 125, and a planarization layer 127 and a pixel defining layer (PDL) 128 are sequentially formed so as to cover the source electrode 126a and the drain electrode 126b, respectively.

The gate insulating layer 123, the interlayer insulating layer 125, the planarization layer 127, and the pixel defining layer (PDL) 128 may be formed as an insulator, and may be formed in a single layer or a multi-layer structure, and an organic material, an inorganic material or an organic/inorganic composite material may be used.

The stack structure of the active layer 122, which is used to form the TFT described above, is not limited thereto, and TFTs having various structures may be formed.

A pixel electrode 129a, which is one electrode of an organic light-emitting diode (OLED), is formed on the planarization layer 127, and the PDL 128 is formed on the pixel electrode 129a. After a predetermined opening is formed in the PDL 128, thereby exposing the pixel electrode 129a, an organic emission layer 129b of the OLED is formed.

The OLED displays predetermined image information by emitting red, green, and blue light according to the flow of current. The OLED includes the pixel electrode 129a which contacts the drain electrode 126b of the TFT via a contact hole, an opposite electrode 129c which covers all pixels, and the organic emission layer 129b which is interposed between the pixel electrode 129a and the opposite electrode 129c, and which emits light.

The pixel electrode 129a and the opposite electrode 129c are insulated from each other by the organic emission layer 129b. Voltages having different polarities are applied to the organic emission layer 129b so that light may be emitted from the organic emission layer 129b.

The organic emission layer 129b may be a low molecular weight organic film or a polymer organic film. The organic emission layer 129 may be formed by stacking a hole injection layer (HIL), a hole transport layer (HTL), an emission layer (EML), an electron transport layer (ETL), and an electron injection layer (EIL) in a single structure or a composite structure, and may be formed of any of various organic materials, such as copper phthalocyanine (CuPc), N,N′-Di(naphthalene-1-yl)-N,N′-diphenyl-benzidine (NPB), or tris-8-hydroxyquinoline aluminum (Alq3). The organic emission layer 129 may be formed by vacuum deposition. The HIL, the HTL, the ETL, and the EIL are common layers, and may be commonly applied to red, green, and blue pixels. Accordingly, unlike the emission unit 120 in FIG. 2, the common layers may be formed so as to cover all pixels like the opposite electrode 129c.

The pixel electrode 129a functions as an anode electrode, and the opposite electrode 129c functions as a cathode electrode. Of course, the polarities of the pixel electrode 129a and the opposite electrode 129c may be reversed.

When the emission unit 120 is a bottom emission type in which an image is displayed in a direction toward the first substrate 110, the pixel electrode 129a may be a transparent electrode, and the opposite electrode 129c may be a reflection electrode. In this regard, the pixel electrode 129a may be formed of an oxide having a high work function, such as ITO, IZO, ZnO, or In₂O₃, and the opposite electrode 129c may be formed of metal having a low work function, such as silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), or the like.

When the emission unit 120 is a top emission type in which an image is displayed in a direction toward the opposite electrode 129c, the pixel electrode 129a may be a reflection electrode, and the opposite electrode 129c may be a transparent electrode. In this regard, the reflection electrode, which constitutes the pixel electrode 129a, may be formed by including a reflection film formed of Ag, Mg, Al, Pt, Pd, Au, Ni, Nd, Ir, Cr, Li, Ca, or a compound of these materials, or an oxide having a high work function, such as ITO, IZO, ZnO, or In₂O₃. The transparent electrode, which constitutes the opposite electrode 129c, may be formed by depositing metal having a low work function, such as Ag, Mg, Al, Pt, Pd, Au, Ni, Nd, Ir, Cr, Li, or Ca, or a compound thereof, and by forming an auxiliary electrode layer or a bus electrode line on the deposited resultant structure by using a transparent conductive material, such as ITO, IZO, ZnO, or In₂O₃.

When the emission unit 120 is a double sided emission type, both the pixel electrode 129a and the opposite electrode 129c may be transparent electrodes.

When the first substrate 110 is seated on a frame (not shown), the emission unit 120 may be a top emission type in which an image is displayed in a direction toward the second substrate 150. Of course, although not shown, a predetermined opening is formed in the frame (not shown), and when a bottom surface of the first substrate 110 is exposed through the opening, both a bottom emission type and a both side emission type may be used.

Materials for forming the pixel electrode 129a and the opposite electrode 129c are not limited to the above-described materials, and the pixel electrode 129a and the opposite electrode 129c may be formed of a conductive organic material or a conductive paste including conductive particles, such as Ag, Mg, Cu, or the like. When the conductive paste is used to form the pixel electrode 129a and the opposite electrode 129c, the conductive paste may be printed using inkjet printing, may be fired after being printed, and may be formed as an electrode.

A passivation layer 10 formed of an inorganic material, an organic material or an organic/inorganic composite stack material may be further formed on a top surface of the opposite electrode 129c of the emission unit 120 so as to cover the emission unit 120.

The supports 130 are disposed in the non-active areas 111 of the first substrate 110, and are separated from the connection members 140 by a predetermined distance. In detail, based on the first flat panel display device 100a, the supports 130 are disposed in the outermost circumferential region of the first substrate 110, and support the first substrate 110 and the second substrate 150. There are a plurality of supports 130, and the supports 130 are separated from one another along the outermost circumferential region of the first substrate 110. Also, based on the first flat panel display device 100a and the second flat panel display device 100b, the supports 130 are disposed so as to correspond to a cutting line Q for classifying the first flat panel display device 100a and the second flat panel display device 100b. Also, the supports 130 are separated from one another along the cutting line Q. FIGS. 2 thru 5 illustrate the supports 130 only in a position where the first flat panel display device 100a and the second flat panel display device 100b contact each other. However, the present invention is not limited thereto, and the supports 130 may be disposed so as to correspond to the cutting line Q for classifying the flat panel display devices 100, as illustrated in FIG. 1.

The supports 130 forcibly exert a tensile stress on the first substrate 110 and the second substrate 150, and minimize the effect caused by the stress of the adjacent connection members 140, thereby reducing the occurrence of a crack or burr which may occur around the cutting line Q.

The supports 130 may be formed of the same material as that of the connection members 140. Thus, the supports 130 may be glass frit formed of one material or a plurality of materials selected from the group consisting of MgO, CaO, BaO, Li₂O, Na₂O, K₂O, B₂O₃, V₂O₅, ZnO, TeO₂, Al₂O₃, SiO₂, PbO, SnO, P₂O₅, Ru₂O, Rh₂O, Fe₂O₃, CuO, TiO₂, WO₃, Bi₂O₃, Sb₂O₃, lead-borate glass, tin-phosphate glass, vanadate glass, and borosilicate glass. Also, the supports 130 may be formed of an organic material, an inorganic material, or an organic/inorganic composite material which constitutes the emission unit 120. In detail, the supports 130 may be formed of the same one or a plurality of materials selected from the group consisting of materials used to form the interlayer insulating layer 125, the planarization layer 127, and the PDL of the emission unit 120. The interlayer insulating layer 125 may be formed of SiNx or SiO₂. The planarization layer 127 may be formed of one or more materials from among polyacrylates resin, epoxy resin, phenolic resin, polyamides resin, polyimides rein, unsaturated polyesters resin, poly(phenylenethers) resin, poly(phenylenesulfides) resin, and benzocyclobutene (BCB). The PDL 128 may be formed of resin, such as polyimides or the like, or a silica-based inorganic material or the like. Thus, the supports 130 may be formed of the same one or a plurality of materials selected from the group consisting of the aforementioned materials. In an embodiment of the present invention, when the supports 130 are formed of both an organic material and an inorganic material, the height of the supports 130 may be adjusted using the inorganic material. The inorganic material may be metal, silicon nitride, silicon oxide or silicon.

The height of the supports 130 may have a height about 0.4 μm smaller than the height of the connection members 140, or may have a height about 3 μm greater than the height of the connection members 140. The supports 130 are formed so as to minimize the effect of stress between the adjacent connection members 140 which occurs when the connection member 140 of the first flat panel display device 100a and the connection member 140 of the second flat panel display device 100b are sealed by irradiating a laser beam thereonto at a predetermined time interval. Thus, the height of the supports 130 should be approximately a height at which the effect of stress between the adjacent connection members 140 may be absorbed, compared to the height of the connection members 140. First, the upper limit of the height of the supports 130 is about 3 μm greater than the height of the connection members 140. When the height of the supports 130 is about 3 μm greater than the height of the connection members 140, the supports 130 are too high and cannot be sealed using the connection members 140. As a result, when the height of the supports 130 is about 0 to 3 μm greater than the height of the connection members 140, the laser beam is irradiated onto the connection members 140 so that the connection members 140 become molten, and they are connected to one another and are not exfoliated, and thus the supports 130 can be sealed using the connection members 140. Next, the lower limit of the height of the supports 130 is about 0.4 μm smaller than the height of the connection members 140. This is due to the fact that, when the height of the supports 130 is about 0.4 μm smaller than that of the connection members 140, the supports 130 are too low and the effect of stress between the adjacent connection members 140 cannot be minimized. In detail, the supports 130 cannot control stress between the adjacent connection members 140.

Referring to FIG. 5, the width W1 of the supports 130 is about 200 to 400 μm. The supports 130 are disposed in such a way that the cutting line Q of the first flat panel display device 100a and the second flat panel display device 100b is a central axis. Thus, a half width W1/2 of one of the supports 130 may be about 100 to 200 μm based on the cutting line Q. In this regard, the width W1 of the support 130 is about 200 μm or more in consideration of a cutting process margin of 25 μm in a lateral direction. However, the present invention is not limited thereto, and the width W1 of the supports 130 may be varied if necessary. Also, when the width W1 of the support 130 is greater than about 400 μm, the connection members 140 and the supports 130 become close, and the connection members 140 become molten and are connected to one another, and then may be exfoliated. However, unless it is a special case, the present invention is not limited thereto. For example, this case corresponds to a case where a distance between the connection members 140 and the supports 130 is small. Thus, when the distance is greater than 300 μm or more, the distance does not need to be limited to 400 μm or less.

Referring to FIGS. 2 thru 5, there are a plurality of supports 130, and the supports 130 may be separated from one another. Although five supports 130 formed between the first flat panel display device 100a and the second flat panel display device 100b are illustrated, the number of supports 130 is not limited thereto. In an embodiment of the present invention, when the supports 130 are separated from one another, a distance W2 between the supports 130 is greater than or equal to the width W1 of the supports 130. For example, the distance W2 between the supports 130 may be about 200 to 400 μm. First, when the distance W2 between the supports 130 is smaller than about 200 μm, and when a reinforcement material 160 is filled around the supports 130, the reinforcement material 160 does not flow smoothly, and it takes time to fill the reinforcement material 160, and thus productivity may be reduced. Referring to FIG. 4B, a reinforcement material 160 is filled around outer portions of the supports 130 and in a space formed between the first and second substrate 110, 150. Outer portions of the supports 130 are sides corresponding to insides of the connection members 140 in a direction toward the emission unit 120. Thus, the reinforcement material 160 may be filled around the supports 130.

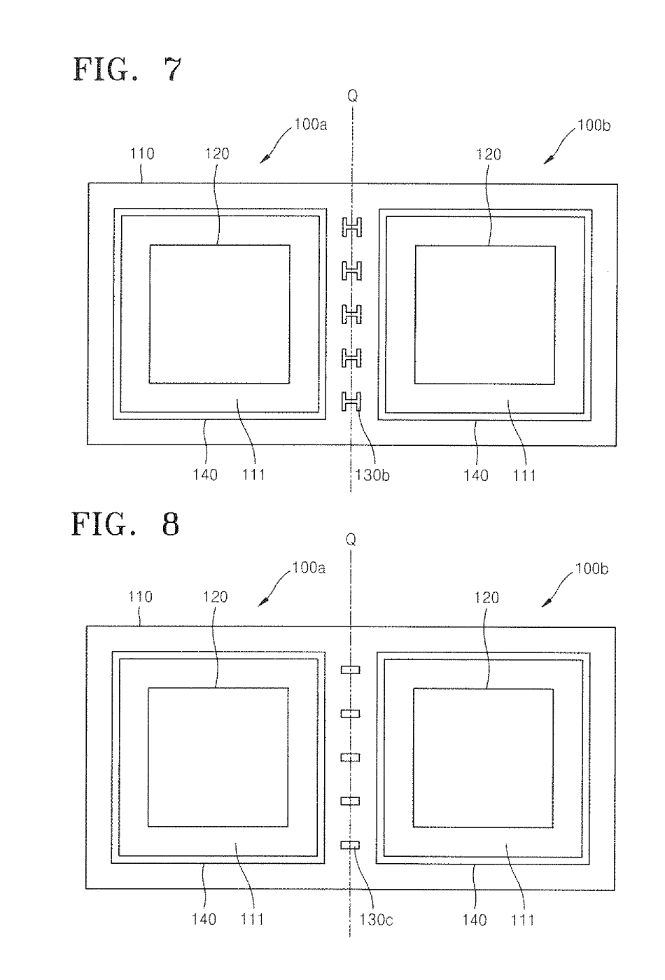

The supports 130 may have various shapes. FIGS. 6 thru 8 are schematic plan views of the flat panel display device 100 according to another embodiment of the present invention.

Referring to FIGS. 5 and 6, supports 130 and 130a may have polygonal or circular cross-sections. Referring to FIGS. 7 and 8, the supports 130 may have such a shape as to form a space in which the reinforcement material 160 in FIG. 4B is filled around the support 130. Thus, cross-sections of the supports 130b and 130c in FIGS. 7 and 8, respectively, may be H-shaped and bar-shaped. However, the present invention is not limited thereto, and cross-sections of the supports 130b and 130c may have other shapes, such as oval, diamond, or trapezoidal shapes, or the like, which may be design-changed by one of ordinary skill in the art. In FIGS. 7 and 8, a sufficient space for filling the reinforcement material 160 in FIG. 4B is formed, and when the reinforcement material 160 in FIG. 4B is filled, the flow of the reinforcement material 160 in FIG. 4B is not disturbed so that a reinforcement rate may be improved and time required for filling may be reduced.

In embodiments of the present invention, a crack or burr may be prevented from occurring around the cutting line Q without the need for performing annealing or for increasing a sealing time.

When, experimentally, the supports 130 are formed of glass frit and are cut along the cutting line Q, a burr of 50 μm on average has occurred. Also, after the supports 130 are formed of an organic layer, including the PDL 128 and the interlayer insulating layer 125, and are cut along the cutting line Q, a burr of 94 μm on average has occurred. Generally, a burr in the range of 200 μm, which is a reference value, has occurred. Thus, according to the present invention, a burr may be prevented from occurring around the cutting line Q.

As described above, in a flat panel display device according to one or more embodiments of the present invention, a crack or burr may be prevented from occurring around a cutting line without having to perform annealing or increase a sealing time.

Since elements shown in the drawings are exaggerated or reduced for convenience of explanation, the present invention is not confined to the sizes or shapes of the elements. While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A flat panel display device, comprising:
a first substrate comprising a plurality of active areas and a plurality of non-active areas;
an emission unit disposed in the plurality of active areas;
a second substrate connected to the first substrate;
a plurality of connection members respectively disposed in the plurality of non-active areas for combining the first substrate and the second substrate with each other; and
a plurality of supports disposed between the adjacent connection members and respectively separated from the connection members for supporting the first and second substrates;
wherein the plurality of supports are separated from one another.

2. The flat panel display device of claim 1, wherein the supports comprise a material the same as material used to form the connection members.

3. The flat panel display device of claim 1, wherein the supports comprise one of an organic material, an inorganic material and an organic/inorganic composite material for forming the emission unit.

4. The flat panel display device of claim 3, wherein the supports comprise at least one material selected from a group consisting of materials used to form an interlayer insulating layer, a metal layer, a planarization layer, and a pixel defining layer.

5. The flat panel display device of claim 1, wherein a height of the supports is not less than a height of the connection members.

6. The flat panel display device of claim 5, wherein the height of the supports is greater than the height of the connection members by no more than 3 μm.

7. The flat panel display device of claim 1, wherein a height of the supports is not greater than a height of the connection members.

8. The flat panel display device of claim 7, wherein the height of the supports is smaller than the height of the connection members by no more than 0.4 μm.

9. The flat panel display device of claim 1, wherein a width of the supports is in a range of 200 μm to 400 μm.

10. The flat panel display device of claim 1, wherein, when the plurality of supports are separated from one another, a distance between the supports is not less than a width of the supports.

11. The flat panel display device of claim 1, wherein cross-sections of the supports are one of polygonal and circular.

12. The flat panel display device of claim 1, further comprising a reinforcement material filled around the supports, around outer portions of the connection members, and in a space formed between the first and second substrate, wherein the supports have a shape for forming a space in which the reinforcement material is filled.

13. The flat panel display device of claim 12, wherein cross-sections of the supports are one of H-shaped and bar-shaped.

14. The flat panel display device of claim 1, wherein the active areas are formed in portions of the first substrate, and the non-active areas are formed so as to surround the active areas.
